(19) United States
(12) Patent Application Publication
(10) Pub. No.: US 2025/0145740 A1
(43) Pub. Date: May 8, 2025

(54) METHOD AND DEVICE FOR MODIFYING FLUORORESIN

(71) Applicant: Ushio Denki Kabushiki Kaisha, Tokyo (JP)

(72) Inventor: Akihiro SHIMAMOTO, Tokyo (JP)

(73) Assignee: Ushio Denki Kabushiki Kaisha, Tokyo (JP)

(21) Appl. No.: 18/832,832

(22) PCT Filed: Oct. 31, 2022
(86) PCT No.: PCT/JP2022/040629

§ 371 Date: Jul. 24, 2024

(30) Foreign Application Priority Data
Jan. 26, 2022 (JP) 2022-009876

(51) Int. Cl. C08F 8/06; B01J 19/12; C08F 8/02; C08F 8/32

(52) U.S. Cl. CPC C08F 8/06; B01J 19/123; C08F 8/02; C08F 8/32; B01J 2219/0869; B01J 2219/0886; B01J 2219/1203

(57) ABSTRACT

Provided are an improved method and device for modifying a fluororesin. The method for modifying a fluororesin includes: a first step in which a first fluid containing an organic compound including at least one of an oxygen atom and a nitrogen atom is irradiated with ultraviolet light exhibiting intensity in at least a wavelength region of 205 nm or less, and the first fluid that has been irradiated with the ultraviolet light is brought into contact with a fluororesin; and a second step in which a second fluid containing water in the form of gas or mist is irradiated with the ultraviolet light, and the second fluid that has been irradiated with the ultraviolet light is brought into contact with the fluororesin.

### TECHNICAL FIELD

The present invention relates to a method and device for modifying a fluororesin.

### BACKGROUND ART

A method for hydrophilically modifying a hydrophobic fluororesin has been known.

Patent Document 1 discloses a method in which a substrate 91 made of a fluororesin is brought into contact with the surface of an aqueous ethanol solution 90, and a principal surface 92 of the substrate 91 in contact with the aqueous ethanol solution 90 is irradiated with ultraviolet light from an ArF excimer laser to hydrophilically modify the principal surface 92 (see FIG. 10).

### PRIOR ART DOCUMENT

### Patent Document

Patent Document 1: JP-A-6-279590

### SUMMARY OF THE INVENTION

### Problems to be Solved by the Invention

Patent Document 1 discloses two methods for irradiating the principal surface 92 with ultraviolet light. As shown in FIG. 10, the first method is a method in which a light source 95a is disposed above a container 93 that stores the aqueous ethanol solution 90 so that the principal surface 92 is irradiated with ultraviolet light L8 that has entered the substrate 91 from the back surface side and passed through the substrate 91. The second method is a method in which a light source 95b is disposed below the container 93 so that the principal surface 92 is irradiated with ultraviolet light L9 that has passed through the container 93 and the aqueous ethanol solution 90.

When the first method is adopted, there are two problems: one is that since the ultraviolet light L8 passes through the substrate 91, only a thin substrate can be processed, and even when a substrate to be processed is thin, the ultraviolet light L8 is absorbed by the substrate 91 so that the amount of the ultraviolet light L8 that reaches the principal surface 92 reduces; and the other is that the fluororesin constituting the substrate 91 is altered by the ultraviolet light L8. When the second method is adopted, there is a problem that the ultraviolet light L9 is absorbed or scattered by the aqueous ethanol solution 90 when passing through the container 93 and the aqueous ethanol solution 90 so that the amount of the ultraviolet light L9 that reaches the principal surface 92 significantly reduces.

In light of these problems, it is an object of the present invention to provide an improved method and device for modifying a fluororesin.

### Means for Solving the Problems

The present invention is directed to a method for modifying a fluororesin, the method including:
a first step in which a first fluid containing an organic compound including at least one of an oxygen atom and a nitrogen atom is irradiated with ultraviolet light exhibiting intensity in at least a wavelength region of 205 nm or less, and the first fluid that has been irradiated with the ultraviolet light is brought into contact with a fluororesin; and
a second step in which a second fluid containing water in the form of gas or mist is irradiated with the ultraviolet light, and the second fluid that has been irradiated with the ultraviolet light is brought into contact with the fluororesin.

In the present invention, ultraviolet light exhibiting intensity in at least a wavelength region of 205 nm or less is used for radicalization of an organic compound including at least one of an oxygen atom and a nitrogen atom in the first step and for radicalization of water in the form of gas or mist in the second step.

Terms used herein will be described. The term “radical” refers to an atom or molecule having an unpaired electron. Although details will be described later, a radical has an unpaired electron and is therefore highly reactive with another molecule. The term “radicalization” refers to producing a radical from a radical source. The term “organic compound including at least one of an oxygen atom and a nitrogen atom” means that the molecular structure of the organic compound has at least one of an oxygen atom and a nitrogen atom.

The first fluid contains an organic compound including at least one of an oxygen atom and a nitrogen atom. The organic compound is present in the form of gas, liquid, or mist in the first fluid. In the first step, the organic compound including at least one of an oxygen atom and a nitrogen atom is radicalized by the ultraviolet light. Radicals obtained from the organic compound including at least one of an oxygen atom and a nitrogen atom hydrophilize the surface of the fluororesin exhibiting hydrophobicity. In the second step, water molecules (H₂O) contained in the second fluid are radicalized by the ultraviolet light so that OH radicals and hydrogen radicals are produced. The produced OH radicals and hydrogen radicals hydrophilize the surface layer of the fluororesin. The term “surface layer” includes the surface of the object and the inner part in the vicinity of surface of the object.

In the present invention, ultraviolet light is used for radicalization of the first fluid and the second fluid, and produced radicals are used for hydrophilization of surface layer of the fluororesin. In Patent Document 1, an aqueous ethanol solution is irradiated with ultraviolet light from an ArF excimer laser, but the purpose of irradiation with ultraviolet light in Patent Document 1 is not to radicalize water molecules in the aqueous ethanol solution but to radicalize ethanol molecules in the aqueous ethanol solution. The present invention is greatly different in this point from Patent Document 1.

In the second step, an object to be irradiated with the ultraviolet light is a second fluid containing water in the form of gas or mist. The phrase “second fluid containing water in the form of gas or mist” means that the second fluid has gaseous H₂O (i.e., water vapor) or H₂O that is in a liquid state but is constituted from particles that can be suspended in the fluid. The amount of attenuation of ultraviolet light due to passing through the second fluid in the form of gas or mist is smaller than the amount of attenuation of ultraviolet light due to passing through water stored in a container, and therefore the fluororesin can be irradiated with a larger amount of ultraviolet light. This makes it possible to more promote hydrophilization than ever before.

The hydrophilization of surface of the fluororesin refers to processing for enhancing the affinity of the surface for water molecules. The hydrophilicity of surface of the fluororesin is enhanced by replacing a fluorine atom present on the surface of the fluororesin with a polar functional group containing no fluorine atom. Although details will be described later, when the fluororesin is modified from hydrophobic to hydrophilic, for example, the fluororesin can tightly be joined with another material.

The second step may be performed after the first step, or the first step and the second step may be performed at the same time. As one of methods for performing the first step and the second step at the same time, a mixed fluid in the form of gas or mist obtained by mixing the first fluid in the form of gas or mist and the second fluid in the form of gas or mist may be irradiated with the ultraviolet light. Although details will be described later, when the mixed fluid is irradiated with the ultraviolet light, the organic compound in the first fluid and water molecules in the second fluid are radicalized at the same time so that the surface layer (i.e., the surface and the inner part in the vicinity of the surface) of the fluororesin is hydrophilized. By hydrophilizing not only the surface but also the inner part in the vicinity of the surface, joint strength is improved. Further, by performing a plurality of steps at the same time, processing time is reduced and a device and a system can be simplified. It should be noted that when the second step is performed after the first step, the first fluid may contain an organic compound present as a liquid.

At least one of the first step and the second step may be performed by irradiating a fluid in contact with the fluororesin with the ultraviolet light. In a case where a fluid in contact with the fluororesin is irradiated with the ultraviolet light, for example, a light source that emits the ultraviolet light and the fluororesin are disposed with a narrow space being interposed therebetween, and in such a state, the fluororesin is irradiated with the ultraviolet light from the light source while the fluid is allowed to flow through the space. This makes it possible to targetably radicalize the fluid that is required for modification processing and is present near the surface of the fluororesin or inside the fluororesin. As a result, many radicals can be brought into contact with the fluororesin.

The organic compound may contain at least one of a hydroxy group, a carbonyl group, and an ether bond. In this case, a functional group containing at least one of a hydroxy group, a carbonyl group, and an ether bond can be formed on the surface of the fluororesin, and therefore high hydrophilicity can be imparted to the surface of the fluororesin.

The organic compound may contain at least one selected from the group consisting of an alcohol, a ketone, an aldehyde, a carboxylic acid, and a phenol.

The organic compound may contain at least one selected from the group consisting of an alcohol having 10 or less carbon atoms and a ketone having 10 or less carbon atoms.

The organic compound may contain at least one selected from the group consisting of an alcohol having 2 or more and 4 or less carbon atoms and acetone. An alcohol having 2 or more and 4 or less carbon atoms and acetone are excellent in easy availability and economic efficiency. An alcohol having 2 or more and 4 or less carbon atoms is excellent in safety and ease of handling. Acetone has a high vapor pressure, which makes it easy to form a relatively high concentration atmosphere.

The organic compound may contain at least one of an amino group, an imino group, and a cyano group.

The organic compound may contain at least one selected from the group consisting of an amine having 4 or less carbon atoms and a nitrile having 4 or less carbon atoms. An amine having 4 or less carbon atoms and a nitrile having 4 or less carbon atoms are excellent in easy availability and economic efficiency.

The ultraviolet light may be produced by a xenon excimer lamp.

The present invention is also directed to a modification device including:
at least one fluid supply port for supplying, into a chamber, a first fluid containing an organic compound including at least one of an oxygen atom and a nitrogen atom and a second fluid containing water in the form of gas or mist; and
a light source that emits ultraviolet light exhibiting intensity in a wavelength region of 205 nm or less toward the first fluid and the second fluid in the chamber,
wherein a surface layer of an object to be processed is hydrophilized by the first fluid that has been irradiated with the ultraviolet light and the second fluid that has been irradiated with the ultraviolet light.

The fluid supply port may be disposed, for example, in the wall or ceiling of the chamber. When there is only one fluid supply port, the fluid supply port is usually connected to both of a supply source of the first fluid and a supply source of the second fluid. However, a combined supply source that supplies both the first fluid and the second fluid may be used. When there is only one fluid supply port and a combined supply source is used, the fluid supply port is connected to the combined supply source. When there is a plurality of fluid supply ports, at least one of the fluid supply ports is connected to a supply source of the first fluid and the other fluid supply port(s) is(are) connected to a supply source of the second fluid. It should be noted that when the fluid supply port is connected to the supply source, a fluid supply channel such as a pipe may be interposed between the fluid supply port and the supply source.

### Effect of the Invention

The present invention makes it possible to provide an improved method and device for modifying a fluororesin.

### BRIEF DESCRIPTION OF THE DRAWINGS

FIG. 1 is a diagram showing an embodiment of a fluororesin modification system.

FIG. 2A is a diagram illustrating a modification mechanism.

FIG. 2B is a diagram illustrating a modification mechanism.

FIG. 2C is a diagram illustrating a modification mechanism.

FIG. 2D is a diagram illustrating a modification mechanism.

FIG. 3A is a diagram illustrating a modification mechanism.

FIG. 3B is a diagram illustrating a modification mechanism.

FIG. 3C is a diagram illustrating a modification mechanism.

FIG. 3D is a diagram illustrating a modification mechanism.

FIG. 4 is a diagram illustrating a first modification of a fluid supply source.

FIG. 5 is a diagram illustrating a second modification of a fluid supply source.

FIG. 6 is a diagram illustrating a first modification of a modification device.

FIG. 7 is a diagram illustrating a second modification of a modification device.

FIG. 8A shows ATR-FTIR analytical results of surface layers of five samples.

FIG. 8B shows ATR-FTIR analytical results of surface layers of five samples.

FIG. 9 is a graph showing a relationship between processing time and contact angle.

FIG. 10 is a diagram illustrating a conventional method for modifying a fluororesin.

### MODE FOR CARRYING OUT THE INVENTION

Embodiments of the present invention will be described with reference to the drawings. It should be noted that the drawings disclosed herein merely show schematic illustrations. Namely, the dimensional ratios on the drawings do not necessarily reflect the actual dimensional ratios, and the dimensional ratios are not necessarily the same between the drawings.

### [Outline of Modification System]

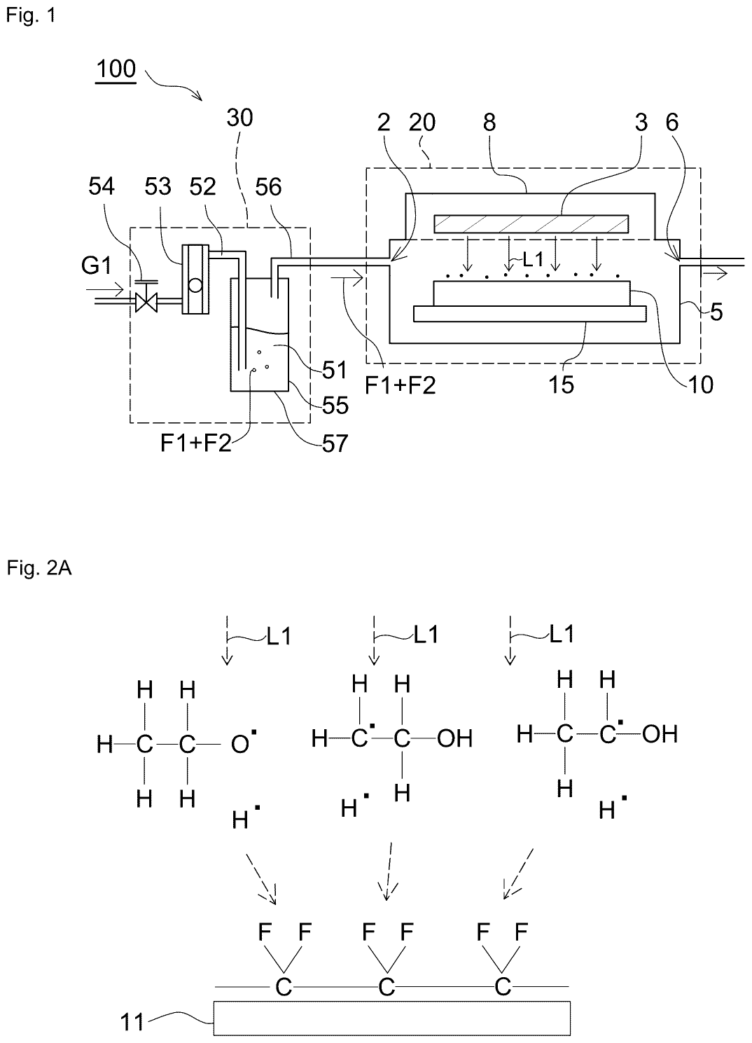

Hereinbelow, an embodiment of a fluororesin modification system and an embodiment of a method for modifying a fluororesin using the modification system will be described. FIG. 1 shows a fluororesin modification system. A modification system 100 includes a modification device 20 and a fluid supply source 30 that supplies a fluid to the modification device 20.

The modification device 20 includes a light source 3 and a fluid supply port 2 connected to the fluid supply source 30. The fluid supply source 30 supplies, to a chamber 5, a first fluid F1 containing an organic compound including at least one of an oxygen atom and a nitrogen atom and a second fluid F2 containing water molecules. The details of the first fluid F1, the second fluid F2, and the fluid supply source 30 will be described later.

Ultraviolet light L1 emitted from the light source 3 is vacuum ultraviolet light and is more specifically ultraviolet light exhibiting intensity in at least a wavelength region of 205 nm or less. The “ultraviolet light exhibiting intensity in at least a wavelength region of 205 nm or less” as used herein is light having an emission band at 205 nm or less. Examples of such light include (1) light exhibiting intensity in a broad wavelength region and showing an emission spectrum whose peak emission wavelength of maximum intensity is 205 nm or less, (2) light showing an emission spectrum having a plurality of maximum intensities (a plurality of peaks), in which any one of the plurality of peaks is located in a wavelength range of 205 nm or less, and (3) light showing an emission spectrum in which integrated intensity of light at 205 nm or less is at least 30% of total integrated intensity.

The light source 3 is, for example, a xenon excimer lamp. The peak emission wavelength of the xenon excimer lamp is 172 nm. Light emitted from the xenon excimer lamp is easily absorbed by the first fluid containing an organic compound including at least one of an oxygen atom and a nitrogen atom and the second fluid containing water in the form of gas or mist. As a result, many radicals are produced from the organic compound including at least one of an oxygen atom and a nitrogen atom and from water molecules.

### [Object to be Processed]

In the present embodiment, an object to be processed 10 is an object formed of a fluororesin as a whole. However, the object to be processed 10 may be an object not formed of a fluororesin as a whole. The object to be processed 10 is not limited as long as it has, in at least part of the surface thereof, a region where a fluororesin is exposed. The object to be processed 10 may be a rigid plate-shaped substrate, a long flexible film, or an object having a three-dimensional shape other than a plate shape.

Specific examples of the object to be processed 10 include medical fluororesins and printed-wiring boards for high-frequency applications. When the surface of a fluororesin is converted from hydrophobic to hydrophilic, joint strength between the fluororesin and another material can be enhanced. In the case of a printed-wiring board, for example, joint strength between a fluororesin as a base material and a copper plating film can be enhanced, and as a result, an effect that the copper plating is less likely to be peeled off is expected to be obtained.

### [Production of Radicals of First Fluid by Modification Device]

The mechanism of production of radicals of the first fluid by the modification device will be described. First, a description will be made with reference to a case where the organic compound includes an oxygen atom. Ethanol (C₂H₅OH) is held up as an example of the organic compound including an oxygen atom. Chemical reaction formulas of the process of producing radicals by irradiating a molecule of ethanol with ultraviolet light (hν) are shown.

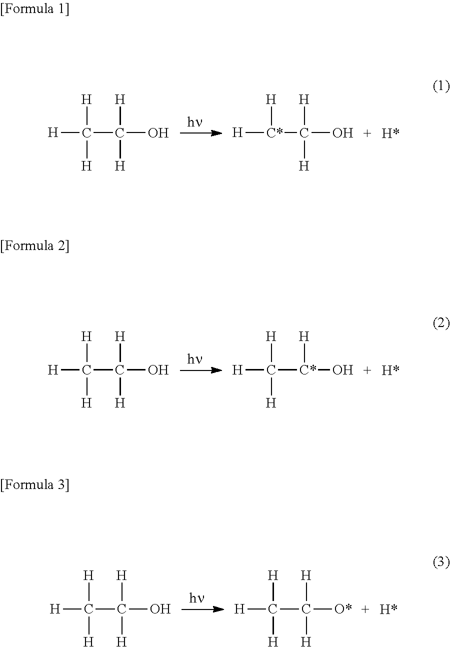

As shown by the above formulas (1) to (3), when a molecule of ethanol is irradiated with ultraviolet light (hν), energy of the ultraviolet light breaks a bond between atoms constituting the molecule of ethanol to produce a radical composed of a carbon atom, a hydrogen atom, and an oxygen atom (sometimes referred to as “{CHO} radical”) and a hydrogen radical (sometimes referred to as “H·”). The {CHO} radicals include one having radicalized C and one having radicalized O. Three types of {CHO} radicals shown in the above formulas (1) to (3) are formed depending on which of C and O is radicalized and which of the carbon atoms is radicalized. It is not always true that all the {CHO} radicals are produced in equal proportion.

It should be noted that each of the three chemical reaction formulas represented by the above formulas (1) to (3) shows a case where a {CHO} radical having one atom having an unpaired electron is produced. However, a {CHO} radical having two or more atoms each having an unpaired electron may be produced by irradiation with ultraviolet light.

Hereinbelow, a description will be made with reference to a case where the organic compound includes a nitrogen atom. Ethylamine (C₂H₅NH₂) is held up as an example of the organic compound including a nitrogen atom. Chemical reaction formulas of the process of producing radicals by irradiating a molecule of ethylamine with ultraviolet light (hν) are shown.

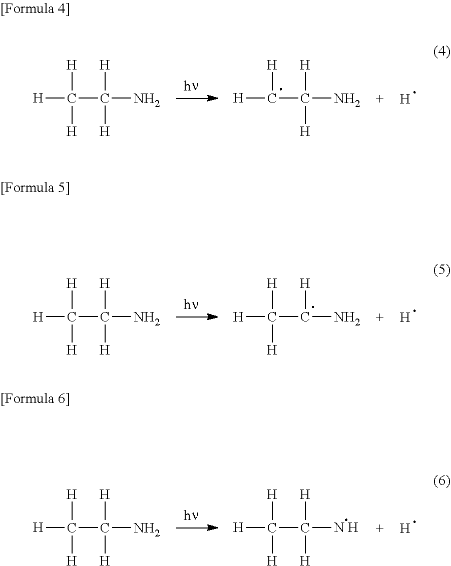

As shown by the above formulas (4) to (6), when a molecule of ethylamine is irradiated with ultraviolet light (hν), energy of the ultraviolet light breaks a bond between atoms constituting the molecule of ethylamine to produce a radical composed of a carbon atom, a hydrogen atom, and a nitrogen atom (sometimes referred to as “{CHN} radical”) and a hydrogen radical. The radical is an atom or molecule having an unpaired electron. The {CHN} radicals include one having radicalized C and one having radicalized N. Three types of {CHN} radicals shown in the above formulas (4) to (6) are formed depending on which of C and N is radicalized and which of the carbon atoms is radicalized. It is not always true that all the {CHN} radicals are produced in equal proportion.

It should be noted that each of the three chemical reaction formulas represented by the above formulas (4) to (6) shows a case where a {CHN} radical having one atom having an unpaired electron is produced. However, a {CHN} radical having two or more atoms each having an unpaired electron may be produced by irradiation with ultraviolet light.

### [Modification Mechanism]

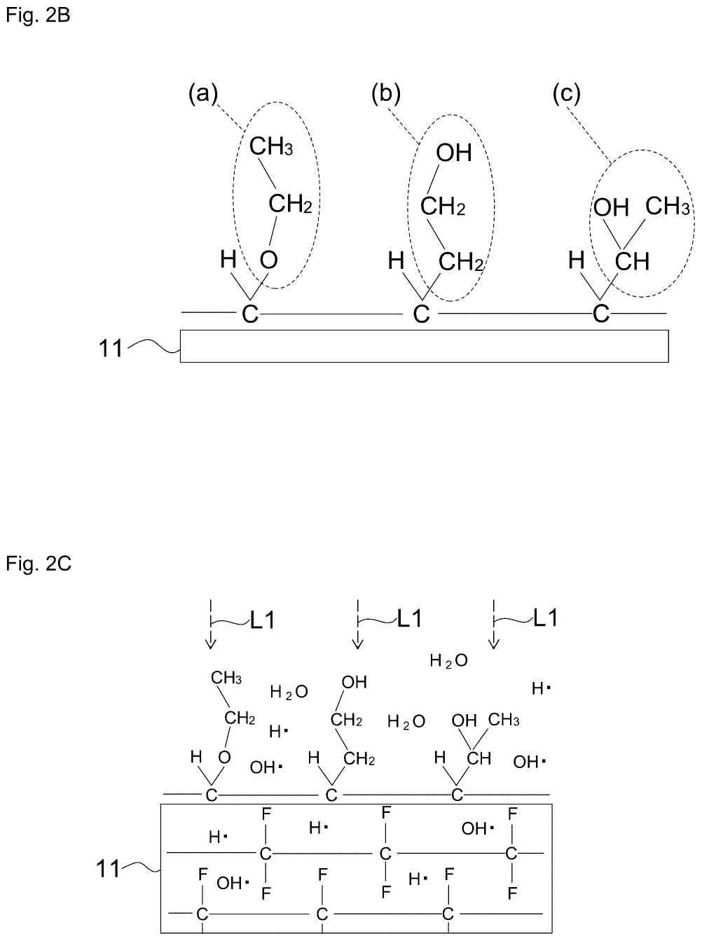

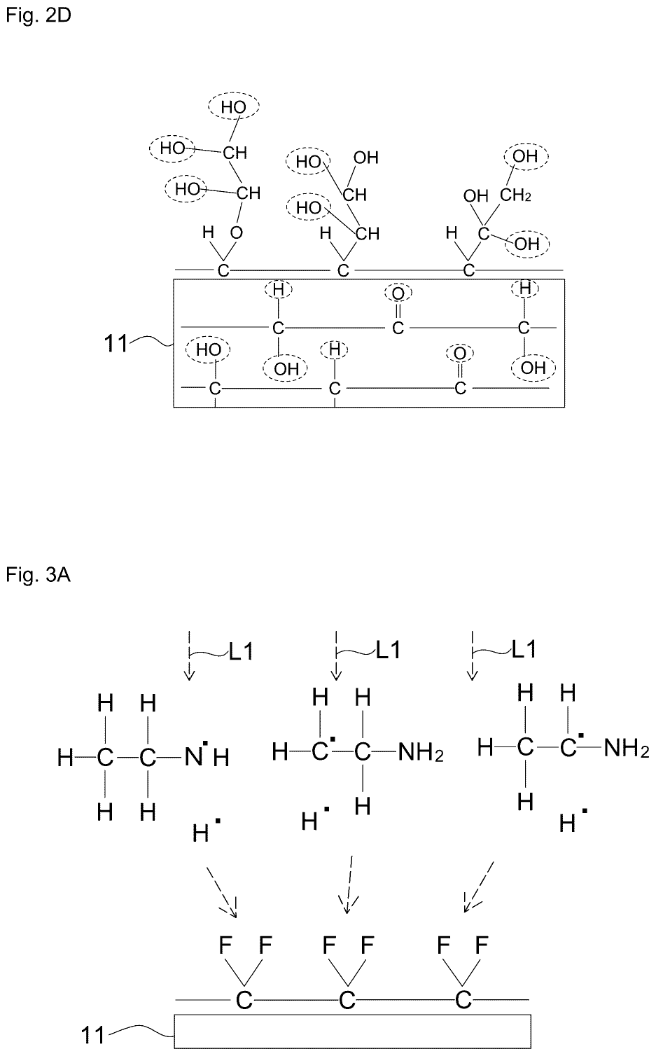

Referring to FIG. 2A to FIG. 2D, the modification mechanism of surface layer of the object to be processed 10 through a first step and a second step will be described with reference to a case where the first fluid is an organic compound including an oxygen atom. FIG. 2A to FIG. 2D are diagrams showing the chemical structure of surface or surface layer of fluororesin of the object to be processed 10 in an understandable way.

FIG. 2A shows a state where radicals are produced immediately before modification of a fluororesin 11 (here, PTFE). As shown in FIG. 2A, a large number of fluorine atoms (F) bonded to carbon atoms (C) are present on the surface of the fluororesin 11 before surface modification. In the vicinity of the surface of the fluororesin 11, {CHO} radicals and hydrogen radicals produced from molecules of ethanol are present.

Fluorine atoms contained in the fluororesin 11 are in a state where they are bonded to carbon atoms. Bond energy between a carbon atom and a fluorine atom is as high as 485 KJ/mol, and therefore a very large amount of energy is required to separate the fluorine atom and the carbon atom by heat or light.

Here, the electronegativity of a fluorine atom is 4.0, and the electronegativity of a hydrogen atom is 2.2. Both of the electronegativities are greatly different from each other. Therefore, electrostatic attraction allows the hydrogen radical to approach the fluorine atom to form HF (hydrogen fluoride), thereby breaking the bond between the fluorine atom and the carbon atom. Bond energy between a hydrogen atom and a fluorine atom is 568 KJ/mol that is higher, and HF is separated from the surface of the fluororesin as a gas, and therefore the production reaction of HF irreversibly proceeds. The {CHO} radical or the hydrogen radical is bonded to a site where fluorine has been extracted from the surface of the fluororesin 11.

FIG. 2B shows the state of the fluororesin 11 shown in FIG. 2A after surface modification by the radicals of the first fluid. FIG. 2B illustrates a state where six fluorine atoms are extracted, hydrogen radicals are bonded to three sites among the sites of the six fluorine atoms, and {CHO} radicals are bonded to the other three sites, but fluorine atoms may remain on the surface. Further, the number of hydrogen radicals bonded may not be the same as the number of {CHO} radicals bonded. For example, {CHO} radicals may be bonded to all the sites where the fluorine atoms have been extracted. On at least part of the surface of the fluororesin 11, a functional group composed of a carbon atom, a hydrogen atom, and an oxygen atom (hereinafter sometimes referred to as “{CHO} functional group”) is present.

The {CHO} functional group represented by (a) in FIG. 2B is formed by bonding the {CHO} radical obtained by the above formula (3) to the fluororesin 11. The {CHO} functional group represented by (b) in FIG. 2B is formed by bonding the {CHO} radical obtained by the above formula (1) to the fluororesin 11. The {CHO} functional group represented by (c) in FIG. 2B is formed by bonding the {CHO} radical obtained by the above formula (2) to the fluororesin 11.

The {CHO} functional group bonded to the fluororesin 11 is polar. Each of the {CHO} functional groups represented by (b) and (c) in FIG. 2B has a hydroxy group at the terminal and therefore exhibits high hydrophilicity. The {CHO} functional group represented by (a) in FIG. 2B forms an ether bond with the fluororesin 11 and is therefore not as hydrophilic as a hydroxy group, but exhibits certain hydrophilicity. It should be noted that in FIG. 2B, different functional groups (a), (b), and (c) are adjacent to each other for explanatory convenience, but actually, the same functional groups may be adjacent to each other.

FIG. 2C shows a state where in the second step, water molecules contained in the second fluid approach the surface of the fluororesin 11, and radicals are produced from the water molecules. As shown in FIG. 2C, when H₂O in the form of gas or mist is irradiated with ultraviolet light, energy of the ultraviolet light breaks an H—O bond in H₂O so that an OH radical (sometimes referred to as (“OH·”) and a hydrogen radical are produced.

FIG. 2D shows the state of surface layer of the fluororesin after the second step. The surface of the fluororesin 11 has a large number of hydrocarbon groups. The OH radical and the hydrogen radical produced from H₂O break a C—H bond included in the hydrocarbon group so that a hydrogen atom is extracted from the hydrocarbon group. Then, as shown in FIG. 2D, the OH radical produced from H₂O is bonded to a site where the hydrogen atom has been extracted. In FIG. 2D, a functional group surrounded by a dashed circle indicates a functional group added in the second step. Thus, by performing the second step, OH groups are added to the hydrocarbon groups added in the first step so that hydrophilization of surface of the fluororesin further proceeds.

In addition, when the surface of the fluororesin 11 is hydrophilized by the first step, as shown in FIG. 2C, water molecules can approach the surface of the fluororesin 11 in the second step. Some of the water molecules can penetrate the inner part in the vicinity of surface of the fluororesin 11. The water molecules that have penetrated the inner part of the fluororesin 11 are decomposed by the ultraviolet light L1 so that hydrogen radicals and OH radicals are produced.

The hydrogen radical present in the inner part in the vicinity of surface of the fluororesin 11 breaks a C—F bond present in the inner part in the vicinity of surface of the fluororesin so that fluorine is extracted. The OH radical is bonded to a site where fluorine has been extracted so that an OH group is produced (see FIG. 2D). It should be noted that a hydrogen atom may be extracted from the OH radical bonded so that a CO group is produced. The CO group is also an oxygen-based functional group exhibiting hydrophilicity. In this way, hydrophilization proceeds also in the inner part in the vicinity of surface of the fluororesin 11. It should be noted that as shown in FIG. 2D, the hydrogen radical may be bonded to a site where fluorine has been extracted.

This is the modification mechanism of surface layer of the fluororesin through a first step and a second step when the first fluid is an organic compound including an oxygen atom. In the modification mechanism, the second step proceeds after the first step in principle. However, both the first step and the second step locally proceed in the chamber in a short period of time. Therefore, the first step and the second step may actually be performed at the same time. This will be described later in detail.

It should be noted that a reaction to produce radicals by irradiating a gas with ultraviolet light proceeds irrespective of pressure, and therefore it is not always necessary to create a reduced-pressure environment in the chamber that is a reaction field. However, in order to replace an atmosphere in the chamber 5 with a desired gas atmosphere in a short time, a vacuum pump may be connected to a fluid discharge port 6 to reduce the pressure in the chamber 5.

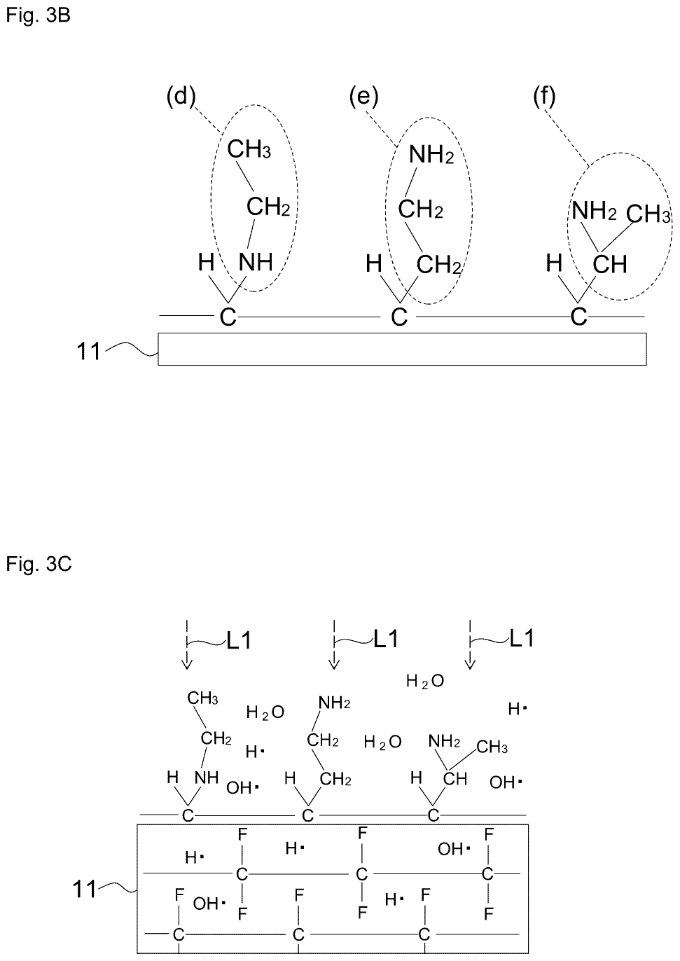

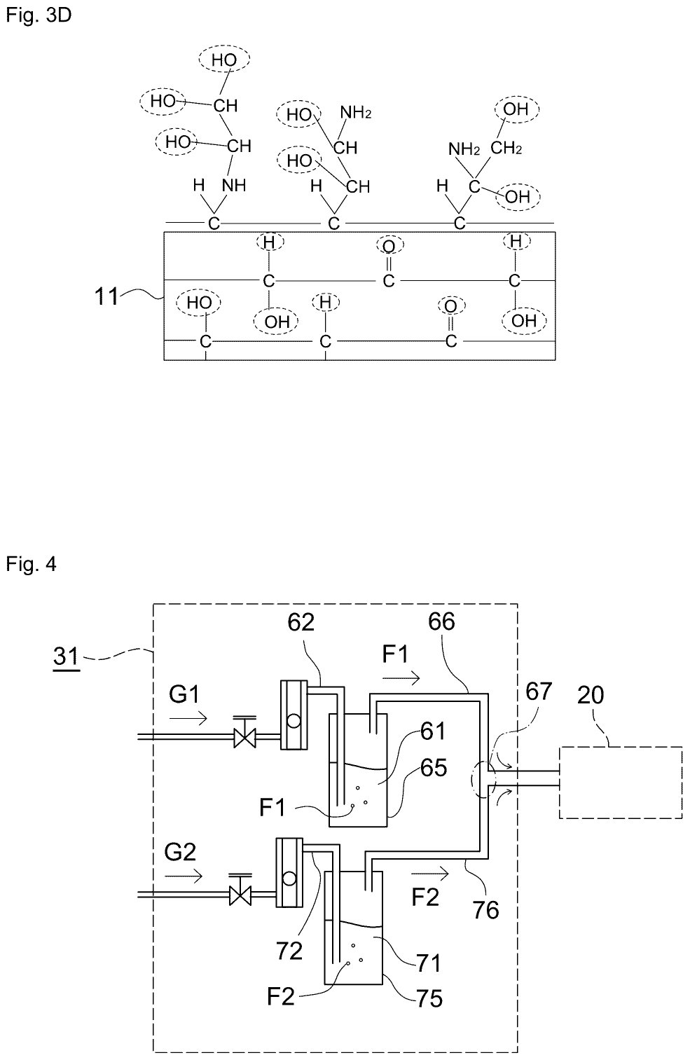

Hereinbelow, referring to FIG. 3A to FIG. 3D, the modification mechanism of surface layer of the object to be processed 10 through a first step and a second step will be described with reference to a case where the first fluid is an organic compound including a nitrogen atom. FIG. 3A to FIG. 3D are diagrams showing the chemical structure of surface or surface layer of fluororesin of the object to be processed 10 in an understandable way. In the following description, overlapping points with the modification mechanism described above with reference to a case where the first fluid is an organic compound including an oxygen atom will sometimes be omitted.

FIG. 3A shows a state where radicals are produced immediately before modification of a fluororesin 11 (here, PTFE). As shown in FIG. 3A, molecules of ethylamine absorb ultraviolet light so that {CHN} radicals and hydrogen radicals are produced. The hydrogen radical breaks a C—F bond. The {CHN} radical or the hydrogen radical is bonded to a site where fluorine has been extracted from the surface of the fluororesin 11.

FIG. 3B shows the state of the fluororesin 11 shown in FIG. 3A after surface modification by the radicals of the first fluid. FIG. 3B illustrates a state where six fluorine atoms are extracted, hydrogen radicals are bonded to three sites among the sites of the six fluorine atoms, and {CHN} radicals are bonded to the other three sites. As shown in FIG. 3B, on at least part of the surface of the fluororesin 11, a functional group composed of a carbon atom, a hydrogen atom, and a nitrogen atom (hereinafter sometimes referred to as “{CHN} functional group”) is present.

In FIG. 3B, the {CHN} functional group represented by (d) is formed by bonding the {CHN} radical obtained by the above formula (6) to the fluororesin 11. In FIG. 3B, the {CHN} functional group represented by (e) is formed by bonding the {CHN} radical obtained by the above formula (4) to the fluororesin 11. In FIG. 3B, the {CHN} functional group represented by (f) is formed by bonding the {CHN} radical obtained by the above formula (5) to the fluororesin 11.

FIG. 3C shows a state where radicals of the second fluid are produced in the second step. FIG. 3D shows the state of surface layer of the fluororesin 11 modified by the produced second fluid. In FIG. 3D, a functional group surrounded by a dashed circle indicates a functional group added in the second step. Also in the case where the first fluid is an organic compound including a nitrogen atom, hydrophilization of surface of the fluororesin further proceeds by performing the second step as in the case where the first fluid is an organic compound including a nitrogen atom.

This is the modification mechanism of surface of the fluororesin through a first step and a second step. In the section “Production of radicals of first gas by modification device” and the section “Modification mechanism”, as the first fluid, ethanol (C₂H₅OH) is held up as an example of the organic compound including an oxygen atom, and ethylamine (C₂H₅NH₂) is held up as an example of the organic compound including a nitrogen atom. However, the first fluid is not limited to these examples, and any fluid can be used for hydrophilization in the first step as long as it contains an organic compound including at least one of an oxygen atom and a nitrogen atom.

However, the organic compound including an oxygen atom preferably contains at least one of a hydroxy group, a carbonyl group, and an ether bond. In this case, a functional group containing at least one of a hydroxy group, a carbonyl group, and an ether bond can be formed on the surface of the fluororesin, and therefore high hydrophilicity can be imparted to the surface of the fluororesin. Particularly, the organic compound including an oxygen atom preferably contains at least one selected from the group consisting of an alcohol, a ketone, an aldehyde, a carboxylic acid, and a phenol. Further, the organic compound including an oxygen atom preferably contains at least one selected from the group consisting of an alcohol having 10 or less carbon atoms and a ketone having 10 or less carbon atoms. Among them, an alcohol having 2 or more and 4 or less carbon atoms and acetone are excellent in easy availability and economic efficiency. Particularly, an alcohol having 2 or more and 4 or less carbon atoms is excellent in safety and ease of handling. Acetone has a high vapor pressure, which makes it easy to form a relatively high concentration atmosphere. The organic compound including a nitrogen atom preferably contains at least one of an amino group, an imino group, and a cyano group. Particularly, at least one selected from the group consisting of an amine having 4 or less carbon atoms and a nitrile having 4 or less carbon atoms is more preferred. For example, methylamine, ethylamine, or acetonitrile is preferred.

### [Fluid Supply Source]

Referring to FIG. 1, the fluid supply source 30 in the present embodiment will be described. The fluid supply source 30 includes a container 55 that stores an aqueous ethanol solution 51 and a carrier gas supply pipe 52 that supplies a carrier gas G1 to the aqueous ethanol solution 51 in the container 55. The aqueous ethanol solution 51 is vaporized by bubbling by feeding the carrier gas G1 into the aqueous ethanol solution 51 so that a first fluid F1 containing ethanol gas and a second fluid F2 containing water vapor can be extracted at the same time and fed to the modification device 20 through a fluid supply pipe 56. In this case, the first step and the second step can be performed at the same time in the modification device 20.

The carrier gas G1 is, for example, an inert gas such as nitrogen gas. The fluid supply source 30 can feed a mixed fluid obtained by mixing the first fluid F1 containing the carrier gas G1 and ethanol gas and the second fluid F2 containing water vapor to the modification device 20 through the fluid supply pipe 56. It should be noted that the second fluid F2 may contain water in the form of mist in addition to water vapor.

The fluid supply source 30 can adjust a mixing ratio between ethanol gas, water vapor, and the carrier gas G1 in the mixed fluid in the modification device 20 by adjusting the amount, temperature, or ethanol concentration of the aqueous ethanol solution 51. The amount of the carrier gas G1 to be supplied can be adjusted using a valve 54 by checking a flowmeter 53. A supply pipe may be provided to supply the aqueous ethanol solution 51 to the container 55. A discharge pipe may be provided to discharge the aqueous ethanol solution 51 from the container 55. A heater may be provided to control the temperature of the aqueous ethanol solution 51 in the container 55. The aqueous ethanol solution 51 used in the present embodiment is one obtained by mixing anhydrous ethanol and water in a ratio of 1:1. It should be noted that anhydrous ethanol herein refers to high-concentration ethanol containing 95 vol % or more of ethanol.

### [Modification Device]

Referring to FIG. 1, details of the modification device 20 will be described. The modification device 20 includes a chamber 5, a light source 3, a fluid supply port 2 to supply a first fluid F1 and a second fluid F2 into the chamber 5, a fluid discharge port 6 to discharge a fluid in the chamber 5 to the chamber 5, and a table 15 on which an object to be processed 10 is to be placed. In the case of the present embodiment, the light source 3 is disposed in a light source chamber 8 disposed on the chamber 5, and the light source chamber 8 and the chamber 5 are separated by a translucent material such as quartz glass.

The modification device 20 is used, for example, in the following procedure. A transport mechanism (not shown) transports an object to be processed 10 from the outside of the modification device 20 onto the table 15. A first fluid F1 and a second fluid F2 are supplied into the chamber 5 through the fluid supply port 2 to replace air in the chamber 5 with the first fluid F1 and the second fluid F2. After the completion of the replacement, modification processing is performed by turning on the light source 3 while the first fluid F1 and the second fluid F2 are continued to be supplied to the chamber 5. After the completion of the modification processing, the light source 3 is turned off, supply of the first fluid F1 and the second fluid F2 is stopped, and the object to be processed 10 on the table 15 is transported to the outside of the chamber 5.

### [Modifications]

The fluid supply source and the modification device may variously be modified. Modifications of the fluid supply source and the modification device will be shown.

Referring to FIG. 4, a first modification of the fluid supply source will be described. A fluid supply source 31 includes a container 65 that stores an ethanol solution 61 and a container 75 that stores liquid water 71.

A carrier gas supply pipe 62 is inserted into the ethanol solution 61, and a carrier gas G1 is fed through the carrier gas supply pipe 62 to vaporize the ethanol solution 61 by bubbling. In this way, a first fluid F1 containing the carrier gas G1 and ethanol gas is extracted. The ethanol solution 61 is preferably high-concentration ethanol or anhydrous ethanol. The ethanol solution 61 may be an aqueous ethanol solution.

A carrier gas supply pipe 72 is inserted into the water 71, and a carrier gas G2 is fed through the carrier gas supply pipe 72 to vaporize the water 71 by bubbling. In this way, a second fluid F2 containing the carrier gas G2 and water vapor is extracted. It should be noted that the water 71 may be vaporized by heating, the water 71 may be vaporized by stirring, or the water 71 may be vaporized by applying ultrasonic vibration. As described above, water contained in the second fluid F2 does not always have to be water vapor, and may be water mist suspended in the carrier gas G1.

A pipe 66 through which the first fluid F1 flows and a pipe 76 through which the second fluid F2 flows are joined together at a joint portion 67 and connected to the modification device 20. It should be noted that the pipe 66 and the pipe 76 may separately be connected to the modification device 20 without joining them together. The carrier gas G1 and the carrier gas G3 may be the same or different from each other.

The mixing ratio between the first fluid F1 and the second fluid F2 can be adjusted by adjusting the flow rate ratio between the carrier gas G1 and the carrier gas G2. At the joint portion 67, a flow rate adjusting valve may be disposed to adjust the mixing ratio between the two fluids.

By flowing the carrier gas G1 without flowing the carrier gas G2, the first fluid F1 can be fed to the modification device without feeding the second fluid F2 to the modification device 20. On the other hand, by flowing the carrier gas G2 without flowing the carrier gas G1, the second fluid F2 can be fed to the modification device 20 without feeding the first fluid F1 to the modification device 20. Further, at the joint portion 67, a three-way valve may be disposed to switch flow between the two fluids. The timing of supply of the first fluid F1 can be made different from the timing of supply of the second fluid F2.

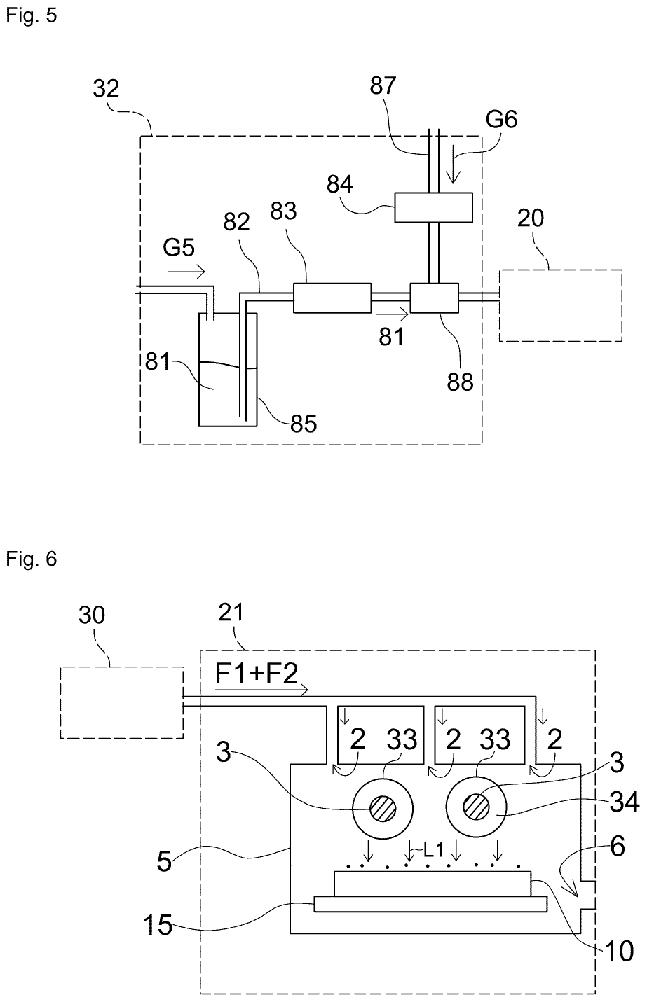

Referring to FIG. 5, a second modification of the fluid supply source will be described. A fluid supply source 32 adopts a direct vaporization system. The fluid supply source 32 includes a container 85 that stores an aqueous ethanol solution 81, a carrier gas supply pipe 87 to flow a carrier gas G6, a vaporizer 88, a mass flow controller 83 to control the amount of the aqueous ethanol solution 81, and a mass flow controller 84 to control the amount of the carrier gas G6. Using the mass flow controllers (83, 84), a certain amount of the carrier gas G6 and a certain amount of the aqueous ethanol solution 81 are supplied to the vaporizer 88. The vaporizer 88 immediately vaporizes all the supplied aqueous ethanol solution 81 using the supplied carrier gas G6. It should be noted that as shown in FIG. 5, the aqueous ethanol solution 81 can be transported from the container 85 by feeding a pressure-feeding gas G5 to the container 85 that stores the aqueous ethanol solution 81. FIG. 5 shows a configuration in which the aqueous ethanol solution 81 containing a first fluid F1 and a second fluid F2 is supplied to the vaporizer 88, but a configuration may be adopted in which the first fluid F1 and the second fluid F2 are separately supplied to the vaporizer 88.

Referring to FIG. 6, a first modification of the modification device will be described. In a modification device 21, two light sources 3 are disposed in such a manner that the longitudinal direction of each of the light sources 3 is parallel to a direction from the front to back of the drawing. A plurality of fluid supply ports 2 for a first fluid F1 and a second fluid F2 are provided in the ceiling of a chamber 1 so that an object to be processed 10 can evenly be processed. In consideration of the flow of the first fluid F1 and the second fluid F2, the positions and number of the fluid supply ports 2 can be set. Also, the positions and number of fluid discharge ports 6 can be set.

Each of the light sources 3 is housed in a tube 33 that extends from the front to back of the drawing. At least part of the tube 33 opposed to the object to be processed 10 is made of a material that transmits ultraviolet light L1, such as quartz glass. A space 34 between the light source 3 and the tube 33 is filled with an inert gas that is less likely to absorb ultraviolet light. The tube 33 prevents an altered substance of the fluid contained in an atmosphere from adhering to the surface of the light source 3 to prevent a reduction in the irradiance of the light source 3.

As shown in FIG. 6, the first fluid F1 and the second fluid F2 may be fed into the chamber 5 at the same time as a mixed fluid (F1+F2). Alternatively, the second fluid F2 may be fed into the chamber 5 after the first fluid F1 is fed into the chamber 5. Further alternatively, the first step and the second step may be performed in different chambers.

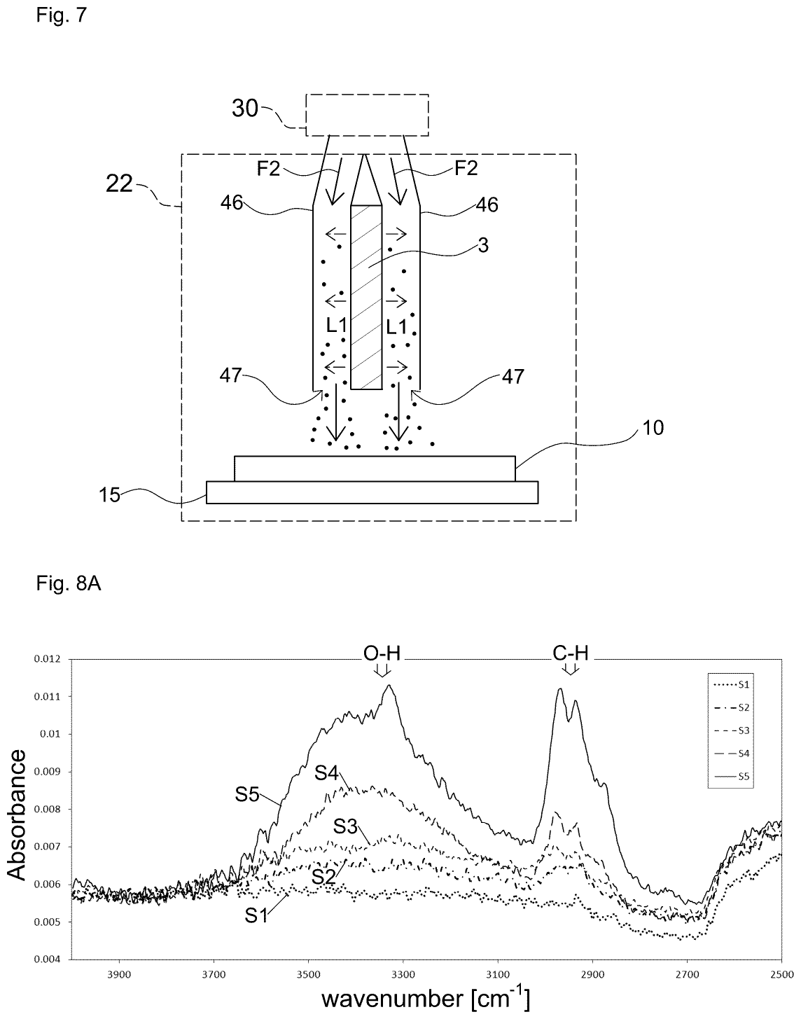

Referring to FIG. 7, a second modification of the modification device will be described. In a modification device 22, a second fluid F2 passing through a pipe 46 is irradiated with ultraviolet light L1 emitted from a light source 3. In this way, the second fluid F2 is radicalized. Then, the second fluid F2 containing hydrogen radicals and OH radicals is sprayed from a tip 47 of the tube 46 toward an object to be processed 10 on a table 15. When the surface of a fluororesin of the object to be processed 10 comes into contact with the hydrogen radicals and the OH radicals, a hydrophilized layer is formed in the surface layer of the object to be processed 10.

In the present embodiment, only a region required to be modified in the object to be processed 10 can selectively be processed by relatively moving the object to be processed 10 and the tip 47 while maintaining a gap between the object to be processed 10 and the tip 47 of the pipe 46. Further, in the present embodiment, an entire processing space surrounded by a chamber, or the like may not be filled with the second fluid F2. It should be noted that the modification device 22 can be used in the same manner also when a first fluid F1 is used and when a mixed fluid of the first fluid F1 and the second fluid F2 is used.

The embodiment of the modification system and the modifications of the fluid supply source and the modification device constituting the modification system have been described above. However, the present invention is not limited to the embodiment and modifications described above, and two or more of the modifications may be combined and various changes or modifications may be made to the embodiment and the modifications without departing from the spirit of the present invention.

### EXAMPLES

The effect of the above-described modification method was verified by ATR-FTIR analysis and an experiment of contact angle measurement.

### [ATR-FTIR Analysis]

As objects to be processed 10, five PTFE (polytetrafluoroethylene) substrates manufactured by Yodogawa Hu-Tech Co., Ltd. were prepared. Four of the five substrates were processed using the modification system 100 according to the embodiment shown in FIG. 1 to hydrophilize the surface layer of each of the object to be processed 10.

Common processing conditions are as follows. In the chamber 5, the substrate was disposed at a distance of 1 mm from the light source 3. As the light source 3, a xenon excimer lamp having a peak wavelength of 172 nm was used. The irradiance on the surface of the light source 3 was 30 mW/cm². Nitrogen gas was fed at 2 L (2×10⁻³ m³)/min as the carrier gas G1 to vaporize a liquid in the container 55 by bubbling. As will be described later, the liquid is different depending on the type of sample.

Samples S1 to S5 respectively have the following features.

TABLE 1

| | |
|---|---|
| Sample S1 | Unprocessed sample |
| Sample S2 | First step 30 sec |
| Sample S3 | First step 120 sec |
| Sample S4 | First step 30 sec/Second step 30 sec |
| Sample S5 | First step 120 sec/Second step 120 sec |

The sample S1 is a substrate (PTFE resin) not subjected to modification processing.

The sample S2 is a sample irradiated with ultraviolet light for 30 seconds in an ethanol gas atmosphere. That is, the sample S2 is a sample obtained by performing only the first step for 30 seconds.

The sample S3 is a sample irradiated with ultraviolet light for 120 seconds in an ethanol gas atmosphere. That is, the sample S3 is a sample obtained by performing only the first step for 120 seconds.

The sample S4 is a sample irradiated with ultraviolet light for 30 seconds in a vaporized aqueous ethanol solution atmosphere. That is, the sample S4 is a sample obtained by performing the first step and the second step for 30 seconds. The aqueous ethanol solution is a liquid obtained by mixing 10 mL (1×10⁻⁵ m³) of anhydrous ethanol and 10 mL (1×10⁻⁵ m³) of water.

The sample S5 is a sample irradiated with ultraviolet light for 120 seconds in a vaporized aqueous ethanol solution atmosphere. That is, the sample S5 is a sample obtained by performing the first step and the second step for 120 seconds. The aqueous ethanol solution used for S5 is the same as that used for S4.

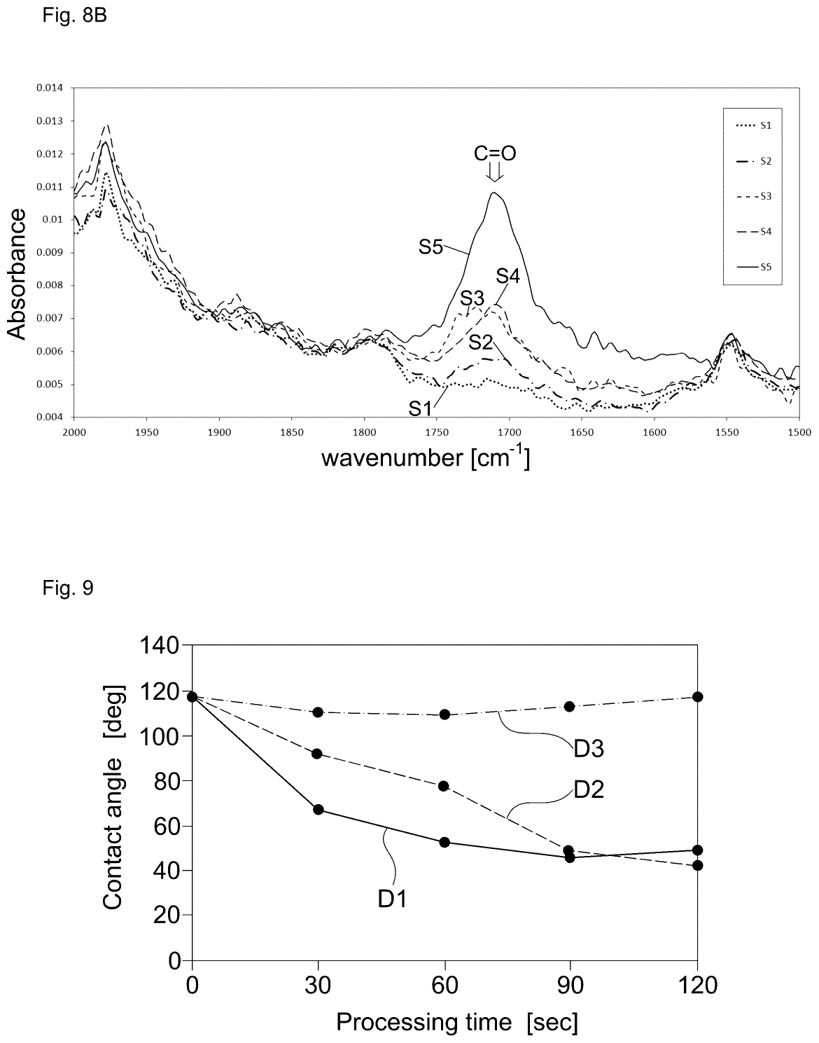

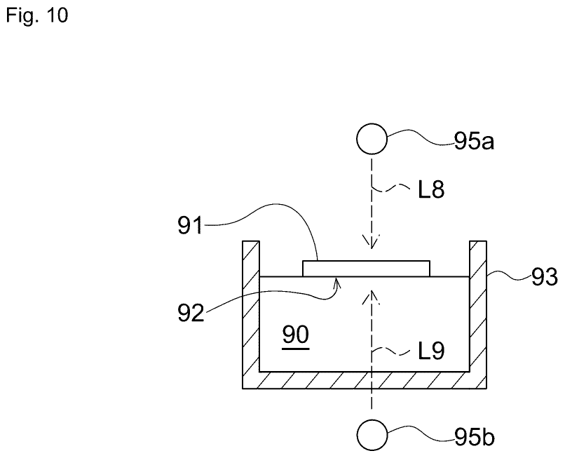

FIG. 8A and FIG. 8B show ATR-FTIR analytical results of surface layers of the five samples. In ATR-FTIR, a crystal having a higher refractive index than a sample is brought into close contact with the surface of the sample, and the sample is irradiated with infrared light from the crystal side to measure totally reflected light, that is, light that penetrates into the surface and its vicinity and is reflected so that an absorption spectrum of surface layer (about 1 μm from the surface) of the sample is obtained. In FIG. 8A and FIG. 8B, the horizontal axis represents wavenumber and the vertical axis represents absorbance. When the absorbance is higher, the energy of absorbed infrared light is larger. In each of FIG. 8A and FIG. 8B, S1 to S5 respectively indicate absorption spectra of the samples S1 to S5. As a measurement device, VERTEX 70v manufactured by Bruker was used. As a high refractive index crystal, diamond was used. The incident angle of infrared light was set to 45 degrees.

An O—H bond in the surface layer shows strong absorption at a wavenumber of about 3300 to 3400 cm⁻¹. A C—H bond in the surface layer shows strong absorption at a wavenumber of about 2900 to 3000 cm⁻¹. As can be seen from FIG. 8A, the number of O—H bonds and C—H bonds in the surface layer of the sample reduces in order of S5, S4, S3, S2, S1. A C═O bond in the surface layer shows strong absorption at a wavenumber of 1700 to 1710 cm⁻¹. As can be seen from FIG. 8B, the number of C═O bonds in the surface layer of the sample reduces in order of S5, S4, S3, S2, S1.

The unprocessed sample S1 hardly contains an O—H bond, a C—H bond, and a C═O bond. From this fact, it was found that O—H bonds, C—H bonds, and C═O bonds were formed by modification of surface layer of the fluororesin. Further, the degree of modification of surface layer of the sample decreases in order of S5, S4, S3, S2. From this fact, it was found that the surface layers of the samples S4 and S5 subjected to modification processing in an aqueous ethanol solution atmosphere were more modified than the surface layers of the samples S2 and S3 subjected to modification processing only in an ethanol gas atmosphere and that the surface layers of the samples S3 and S5 subjected to processing for 120 seconds were more modified than the surface layers of the samples S2 and S4 subjected to processing for 30 seconds.

### [Contact Angle Measurement]

The surface layer of an object to be processed 10 was subjected to hydrophilization processing using the modification system 100 according to the embodiment shown in FIG. 1. As the object to be processed 10, PTFE (polytetrafluoroethylene) manufactured by Yodogawa Hu-Tech Co., Ltd. was used. Nitrogen gas was fed at 2 L (2×10⁻³ m³)/min as the carrier gas G1 into a liquid in the container 55 to vaporize the liquid in the container 55 by bubbling, and a resultant was supplied to the chamber 5. As will be described later, the liquid is different depending on the type of sample. In the chamber 5, the substrate was disposed at a distance of 1 mm from the light source 3. As the light source 3, a xenon excimer lamp having a peak wavelength of 172 nm was used. The irradiance on the surface of the light source 3 was 30 mW/cm². Nitrogen gas was fed at 2 L (2×10⁻³ m³)/min as the carrier gas G1 to vaporize a liquid in the container 55 by bubbling. In order to measure a water contact angle, a contact angle meter DMs-401 manufactured by Kyowa Interface Science Co., Ltd. was used. From a measurement result obtained by the contact angle meter, a contact angle was calculated by elliptical curve fitting. The calculation of contact angle was performed on three points on the surface of the same object to be processed 4. The average of water contact angles measured at three points was calculated and defined as a final water contact angle. The other measurement conditions of the water contact angle were set in accordance with JIS R 3257 “Method for Testing Wettability of Substrate Glass Surface”.

FIG. 9 is a graph showing a relationship between processing time (sec) for modification and contact angle (deg).

The horizontal axis represents the processing time of the object to be processed 10, and the vertical axis represents the water contact angle of surface of the object to be processed 10. A smaller water contact angle indicates that the degree of hydrophilization is higher.

As shown in FIG. 9, the contact angle before processing is 119 degrees, which indicates that hydrophobicity is high. A solid line D1 indicates a measurement result at the time when an aqueous ethanol solution was used as the “liquid in the container 55”, that is, the first fluid and the second fluid were used (i.e., at the time when both the first step and the second step were performed). A broken line D2 indicates a measurement result at the time when an ethanol solution (anhydrous ethanol) was used as the “liquid in the container 55”, that is, only the first fluid was used (i.e., at the time when only the first step was performed). A dash-dotted line D3 indicates a measurement result at the time when water was used as the “liquid in the container 55”, that is, only the second fluid was used.

As can be seen from FIG. 9, when both the first step and the second step were performed, hydrophilization could be achieved in a shorter time as compared to when only the first step was performed. Further, it was found that hydrophilization could not be achieved only by performing the second step but could be achieved by performing the second step in combination with the first step.

### DESCRIPTION OF REFERENCE SIGNS

1 Chamber
2 Fluid supply port
3 Light source
5 Chamber
6 Fluid discharge port
7 Tip
8 Light source chamber
10 Object to be processed
11 Fluororesin
15 Table
20, 21, 22 Modification device
30, 31, 32 Fluid supply source
33 Tube
34 Space
46 Pipe
47 Tip (of pipe)
51, 81 Aqueous ethanol solution
52 Carrier gas supply pipe
53 Flowmeter
54 Valve
55, 65, 75, 85 Container
56 Fluid supply pipe
61 Ethanol solution
62 Carrier gas supply pipe
66, 76 Pipe
67 Joint portion
71 Water
72, 87 Carrier gas supply pipe
83, 84 Mass flow controller
88 Vaporizer
100 Modification system
F1 First fluid
F2 Second fluid
G1, G2, G3, G6 Carrier gas
G5 Pressure-feeding gas
L1 Ultraviolet light

1. A method for modifying a fluororesin, the method comprising:
a first step in which a first fluid containing an organic compound including at least one of an oxygen atom and a nitrogen atom is irradiated with ultraviolet light exhibiting intensity in at least a wavelength region of 205 nm or less, and the first fluid that has been irradiated with the ultraviolet light is brought into contact with a fluororesin; and
a second step in which a second fluid containing water in the form of gas or mist is irradiated with the ultraviolet light, and the second fluid that has been irradiated with the ultraviolet light is brought into contact with the fluororesin.

2. The method according to claim 1, wherein the first step and the second step are performed at the same time by irradiating, with the ultraviolet light, a mixed fluid in the form of gas or mist obtained by mixing the first fluid in the form of gas or mist and the second fluid.

3. The method according to claim 1, wherein the second step is performed after the first step.

4. The method according to claim 1, wherein at least one of the first step and the second step is performed by irradiating a fluid in contact with the fluororesin with the ultraviolet light.

5. The method according to claim 1, wherein the organic compound contains at least one of a hydroxy group, a carbonyl group, and an ether bond.

6. The method according to claim 5, wherein the organic compound contains at least one selected from the group consisting of an alcohol, a ketone, an aldehyde, a carboxylic acid, and a phenol.

7. The method according to claim 6, wherein the organic compound contains at least one selected from the group consisting of an alcohol having 10 or less carbon atoms and a ketone having 10 or less carbon atoms.

8. The method according to claim 7, wherein the organic compound contains at least one selected from the group consisting of an alcohol having 2 or more and 4 or less carbon atoms and acetone.

9. The method according to claim 1, wherein the organic compound contains at least one of an amino group, an imino group, and a cyano group.

10. The method according to claim 9, wherein the organic compound contains at least one selected from the group consisting of an amine having 4 or less carbon atoms and a nitrile having 4 or less carbon atoms.

11. The method according to claim 1, wherein the ultraviolet light is produced by a xenon excimer lamp.

12. A modification device comprising:
at least one fluid supply port for supplying, into a chamber, a first fluid containing an organic compound including at least one of an oxygen atom and a nitrogen atom and a second fluid containing water in the form of gas or mist; and
a light source that emits ultraviolet light exhibiting intensity in a wavelength region of 205 nm or less toward the first fluid and the second fluid in the chamber,
wherein a surface layer of an object to be processed is hydrophilized by the first fluid that has been irradiated with the ultraviolet light and the second fluid that has been irradiated with the ultraviolet light.
